(19) United States
(12) Patent Application Publication
(10) Pub. No.: US 2013/0213554 A1
(43) Pub. Date: Aug. 22, 2013

(54) FITNESS AUXILIARY ROLLER FABRICATION METHOD

(71) Applicant: SING PONG INTERNATIONAL CO., LTD., (US)

(72) Inventor: Victor TSAI, Taipei City (TW)

(73) Assignee: SING PONG INTERNATIONAL CO., LTD., Taipei (TW)

(21) Appl. No.: 13/763,302

(22) Filed: Feb. 8, 2013

(30) Foreign Application Priority Data
Feb. 20, 2012 (TW) 101105504

(51) Int. Cl. B32B 1/08

(52) U.S. Cl. CPC B32B 1/08
USPC 156/93; 156/294

(57) ABSTRACT

A fitness auxiliary roller fabrication method includes the steps of: a) providing a sleeve defining therein a through hole, b) providing a first tube member of a flexible material defining therein a tube hole and an outer diameter approximately equal to the inner diameter of the through hole of the sleeve, c) press-fitting the first tube member into the sleeve, d) providing a second tube member of a hard material, e) inserting the second tube member into the tube hole of the first tube member to expand the first tube member against the sleeve, and f) injecting a bonding adhesive in between the second tube member and the first tube member.

### BACKGROUND OF THE INVENTION

1. Field of the Invention

The present invention relates to fitness auxiliary rollers and more particularly, to a fitness auxiliary roller fabrication method for making a fitness auxiliary roller.

2. Description of the Related Art

With the popularity of rhythmic gymnastics, many fitness auxiliary apparatuses have been created and have appeared on the market. Exemplars are seen in Taiwan Patents M369777 and M405881. Taiwan Patent M369777 discloses a fitness auxiliary apparatus, entitled “Auxiliary rolling apparatus for rhythmic gymnastics”, which includes an elongated straight body of a molded soft foam material defining therein a through hole that enables the elongated straight body to be elastically deformed upon a stress. However, subject to the material properties and the design of the through hole, the elongated straight body may be excessively deformed during operation, unable to effectively assist operation changes.

Taiwan Patent M405881 discloses a fitness auxiliary apparatus, entitled “Yuga column”, which comprises a main body, a main body, a receptacle, and at least one cover. The main body is made of sponge or a soft material. The receptacle is an elongated cylindrical member made of plastic or other hard material and mounted in the hollow inside of the main body, defining therein an accommodation portion. The main body and the receptacle are fastened together using a bonding technique. However, during application of the Yuga column, the main body and the receptacle may be deformed, causing separation between the main body and the receptacle.

### SUMMARY OF THE INVENTION

The present invention has been accomplished under the circumstances in view. It is the main object of the present invention to provide a fitness auxiliary roller fabrication method, which enables the component parts thereof to be tightly secured together subject to their material properties.

To achieve this and other objects of the present invention, a fitness auxiliary roller fabrication method comprises the steps of: a) providing a sleeve defining therein a through hole, b) providing a first tube member of a flexible material defining therein a tube hole and an outer diameter approximately equal to the inner diameter of the through hole of the sleeve, c) press-fitting the first tube member into the sleeve, d) providing a second tube member of a hard material, e) inserting the second tube member into the tube hole of the first tube member to expand the first tube member against the sleeve, and f) injecting a bonding adhesive in between the second tube member and the first tube member.

Thus, by means of the material hardness of the second tube member, the structural strength of the fitness auxiliary roller is enhanced. Further, by means of press-fitting the second tube member into the first tube member to expand the first tube member against the sleeve, the first tube member, the second tube member and the sleeve are tightly secured together, eliminating the drawback of the prior art design that simply relies on the bonding effect of the applied bonding adhesive to secure component parts together.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of a fitness auxiliary roller fabrication flow in accordance with the present invention.

FIG. 2 is an exploded view of a fitness auxiliary roller constructed according to the present invention.

FIG. 3 is a schematic sectional assembly view of the fitness auxiliary roller shown in FIG. 2, illustrating the first tube member press-fitted into the sleeve before insertion of the second tube member into the first tube member.

FIG. 4 is a schematic elevational view illustrating the first tube member press-fitted into the sleeve and the second tube member inserted into the first tube member within the sleeve.

FIG. 5 is a schematic sectional view of the present invention, illustrating a bonding adhesive filled into the gap between the first tube member and second tube member of the fitness auxiliary roller shown in FIG. 4.

FIG. 6 is a schematic front view of the fitness auxiliary roller made according to the present invention.

FIG. 7 is a schematic drawing illustrating a design printed on the periphery of the sleeve of the fitness auxiliary roller made according to the present invention.

FIG. 8 is a block diagram of a sleeve fabrication flow for the preparation of the sleeve provided in FIG. 1.

FIG. 9 illustrates a sheet member provided during the sleeve fabrication flow shown in FIG. 8.

FIG. 10 corresponds to FIG. 9, illustrating the sheet member rolled into a tube.

### DETAILED DESCRIPTION OF THE INVENTION

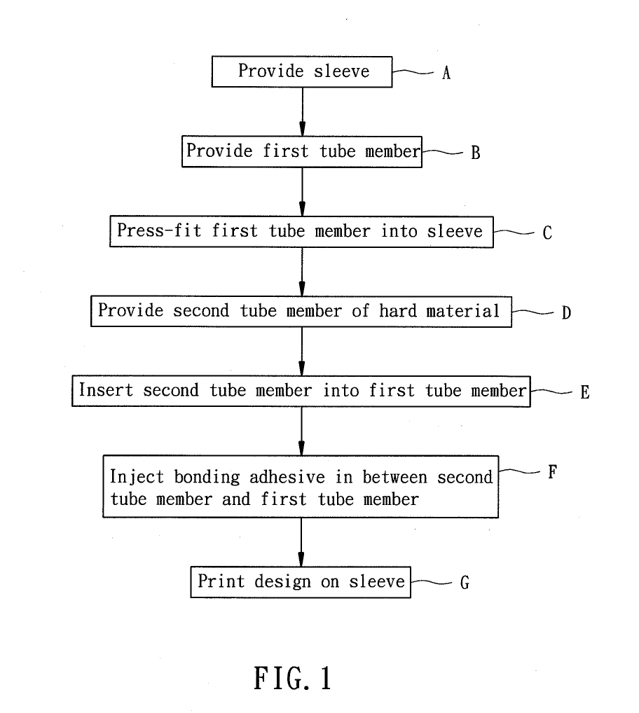

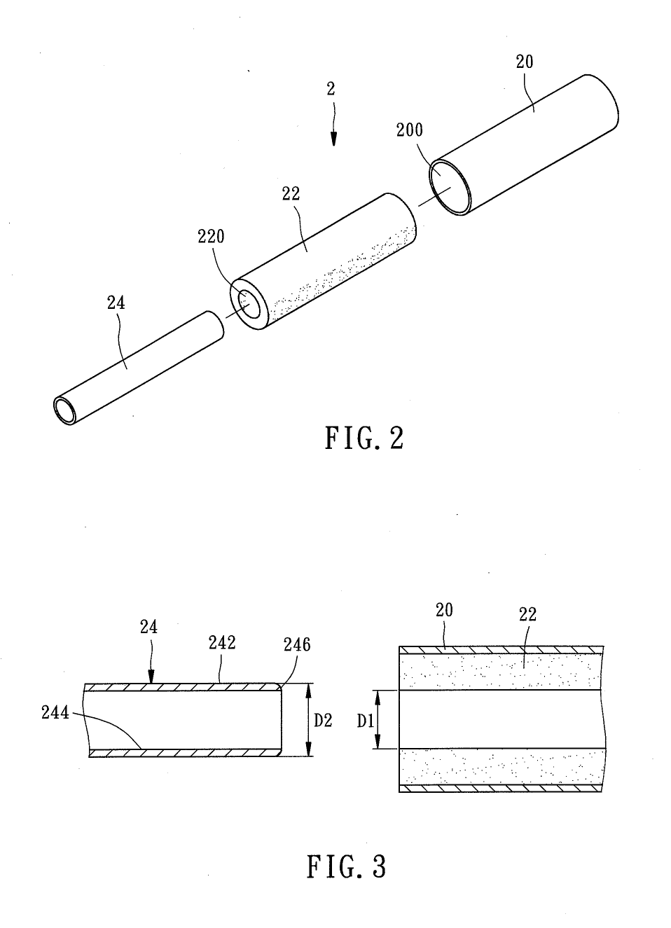

Referring to FIGS. 1 and 2, a fitness auxiliary roller fabrication method in accordance with the present invention is adapted for making a fitness auxiliary roller 2. This fitness auxiliary roller fabrication method includes the following steps:

A: providing a sleeve 20 defining therein a through hole 200;

B: providing a first tube member 22 of a flexible material defining therein a tube hole 220 and an outer diameter approximately equal to the inner diameter of the through hole 200 of the sleeve 20;

C: press-fitting the first tube member 22 into the sleeve 20;

D: providing a second tube member 24 of a hard material;

E: inserting the second tube member 24 into the tube hole 220 of the first tube member 22; and

F: injecting a bonding adhesive in between the second tube member 24 and the first tube member 22.

The structure, material and objective of every component part of the fitness auxiliary roller prepared subject to the aforesaid steps are outlined hereinafter.

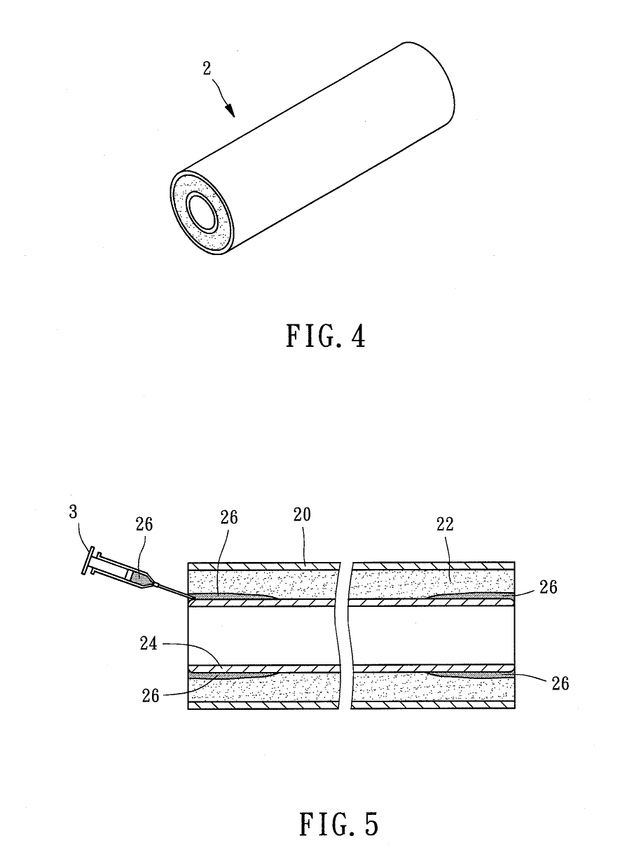

As shown in FIG. 3, the outer diameter D2 of the second tube member 24 is larger than the inner diameter D1 of the first tube member 22. Therefore, when proceeding to step E, the second tube member 24 is press-fitted into the first tube member 22 to expand the first tube member 22, causing the sleeve 20 to be tightly stretched. At this time, the fitness auxiliary roller 2 is assembled, as shown in FIG. 4.

Further, if the outer diameter of the first tube member 22 is slightly larger than the inner diameter of the through hole 200 of the sleeve 20, the first tube member 22 can be expanded when step E is performed, causing the sleeve 20 to be tightly stretched. Therefore, either the inner diameter of the through hole 200 of the sleeve 20 is slightly larger than, smaller than or equal to the outer diameter of the first tube member 22, expanding the first tube member 22 can cause the sleeve 20 to be tightly stretched and wrapped about the first tube member 22.

As shown in FIG. 5, during performance of step F, a syringe 3 can be used and inserted through the first tube member 22 to inject a bonding adhesive 26 into the gap between the outer perimeter of the second tube member 24 and the first tube member 22 in opposing front and rear ends. Actually, a relatively longer injection needle can be used with the syringe 3 to inject the bonding adhesive 26 into the gap in the middle area between the outer perimeter of the second tube member 24 and the first tube member 22. Other injection methods may be selectively used to inject the bonding adhesive 26 into the gap between the outer perimeter of the second tube member 24 and the first tube member 22. After the injected bonding adhesive 26 is cured, the second tube member 24 and the first tube member 22 are tightly bonded together.

Thus, during application of the fitness auxiliary roller 2, the first tube member 22 and the second tube member 24 can be kept tightly bonded together, and the second tube member 24 will never fall out of the first tube member 22 even if the bonding adhesive 26 loses its stick after a long use of the fitness auxiliary roller 2.

Further, the material for the first tube member 22 can be selected from the group of polyethylene, polystyrene, polyvinyl chloride, polypropylene, polyurethane, and ethylene-vinyl acetate copolymer.

Further, the material for the second tube member 24 can be selected from the group of plastics including PVC, ABC, PP, PE, PU and TPE, glass fiber, carbon fiber, and natural materials including bamboo and wood.

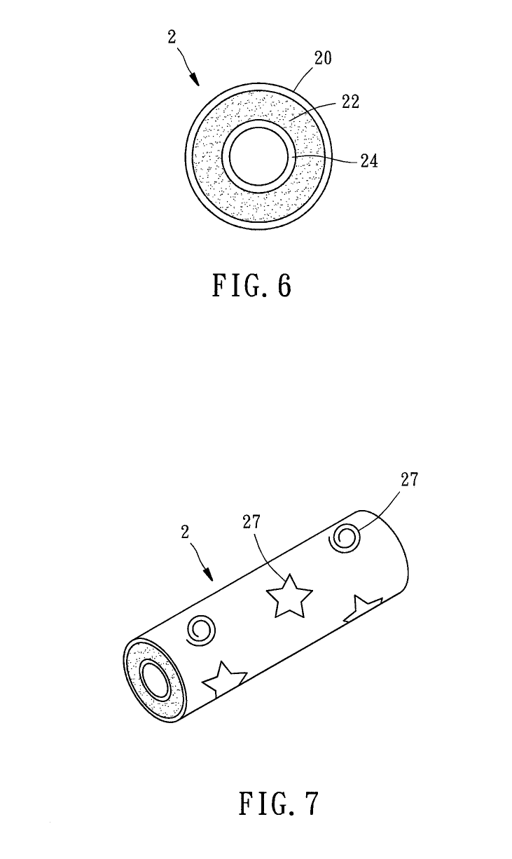

As shown in FIG. 1 and FIG. 6, if the sleeve 20, the first tube member 22 and the second tube member 24 can be tightly joined together after steps A˜E, step F can be omitted without applying the bonding adhesive.

Subject to the aforesaid steps, the fitness auxiliary roller 2 can be accurately assembled. Further, after steps A˜F, step G can be performed to print a design 27 on the outer perimeter of the sleeve 20. This design 27 can be a color, totem, text, lines, or other style, as shown in FIG. 7.

Referring to FIG. 3 again, the second tube member 24 comprises a chamfered guide edge 246 disposed around one end thereof and smoothly curved from an outer wall 242 thereof toward an inner wall 244 thereof. Subject to the chamfered guide edge 246, the second tube member 24 can be easily inserted into the inside of the first tube member 22 during step E. Actually, the second tube member 24 without the chamfered guide edge 246 can still be inserted into the inside of the first tube member 22.

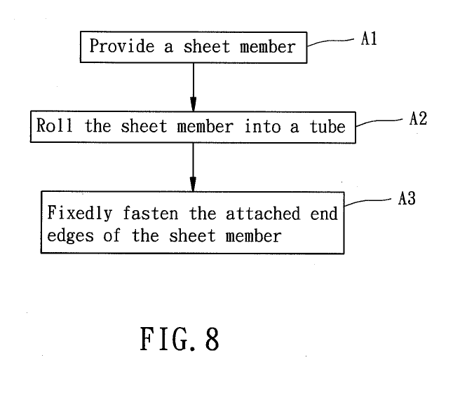

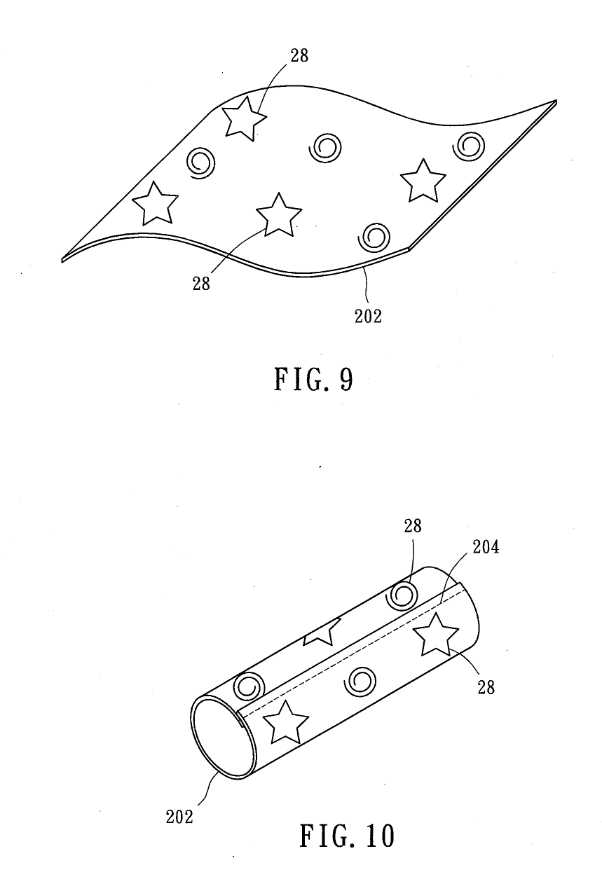

FIG. 8 is a block diagram illustrating the fabrication of the sleeve. As shown in FIGS. 8-10, the sleeve provided in step A is prepared subject to the following steps:

A1: providing a sheet member 202;

A2: rolling the sheet member 202 into a tube to have two opposite end edges 204 of the sheet member 202 be attached together; and

A3: fixedly fastening the attached opposite end edges 204 of the sheet member 202 together.

The sheet member 202 can be a fabric woven from fibers, or made of a plastic material. Fibers can be selected from the group of cotton, flax, nylon, silk and rayon. Plastics can be selected from the group of styrene, butadiene, styrene copolymers, PVC, PP, PE, EVA, NR and other elastic thermoplastic plastics. If the sheet member 202 is a fiber woven fabric, fixedly fasten the attached opposite end edges 204 of the sheet member 202 together with stitches. If the sheet member 202 is a plastic sheet member, fixedly fasten the attached opposite end edges 204 of the sheet member 202 together using a high-frequency heat sealing technique. After steps A1˜A3, the sleeve is kept in a cylindrical shape, and the attached opposite end edges 204 of the sheet member 202 will not be stretched open during step E in FIG. 1.

Further, the design 28 can be printed on the sheet member 202 in step A1 and prior to steps A2 and A3, i.e., the printing of the design 28 of the sleeve can be selectively performed before assembling the fitness auxiliary roller or after the fitness auxiliary roller is assembled. However, this printing procedure can be eliminated if the design is not desired.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fitness auxiliary roller fabrication method, comprising the steps of:
a) providing a sleeve defining therein a through hole;
b): providing a first tube member of a flexible material defining therein a tube hole and an outer diameter approximately equal to the inner diameter of said through hole of said sleeve;
c): press-fitting said first tube member into said sleeve;
d): providing a second tube member of a hard material;
e): inserting said second tube member into said tube hole of said first tube member; and
f): injecting a bonding adhesive in between said second tube member and said first tube member.

2. The fitness auxiliary roller fabrication method as claimed in claim 1, wherein said second tube member comprises a chamfered guide edge disposed around one end thereof and smoothly curved from an outer wall thereof toward an inner wall thereof.

3. The fitness auxiliary roller fabrication method as claimed in claim 1, wherein said bonding adhesive is injected in between said second tube member and said first tube member around opposing front and rear segments of said second tube member during step f).

4. The fitness auxiliary roller fabrication method as claimed in claim 1, wherein said sleeve provided in step a) is prepared subject to the steps of:
a1) providing a sheet member of a fiber woven fabric;
a2) rolling said sheet member into a tube to have two opposite end edges of said sheet member be attached together; and
a3) fixedly fastening the attached end edges of said sheet member together with stitches.

5. The fitness auxiliary roller fabrication method as claimed in claim 1, wherein said sleeve provided in step a) is prepared subject to the steps of:
a1) providing a sheet member of a plastic material;
a2) rolling said sheet member into a tube to have two opposite end edges of said sheet member be attached together; and
a3) employing a high-frequency heat sealing technique to fixedly fasten the attached end edges of said sheet member together.

6. The fitness auxiliary roller fabrication method as claimed in claim 5, wherein said sheet member provided in step a1) has a printed design.

7. The fitness auxiliary roller fabrication method as claimed in claim 4, wherein said sheet member provided in step a1) has a printed design.

8. The fitness auxiliary roller fabrication method as claimed in claim 1, further comprising step g) of printing a design on the outer perimeter of said sleeve after step f).

9. The fitness auxiliary roller fabrication method as claimed in claim 1, wherein said second tube member is selected from the material group of plastics including PVC, ABC, PP, PE, PU and TPE, glass fiber, carbon fiber, and natural materials including bamboo and wood.

10. The fitness auxiliary roller fabrication method as claimed in claim 1, wherein said first tube member is selected from the material group of polyethylene, polystyrene, polyvinyl chloride, polypropylene, polyurethane, and ethylene-vinyl acetate copolymer.
